(19) United States
(12) Patent Application Publication
(10) Pub. No.: US 2008/0298646 A1
(43) Pub. Date: Dec. 4, 2008

(54) Method and Device for Improved Fingerprint Matching

(75) Inventor: Magnus Wennergren, Falkenberg (SE)

Correspondence Address: BUCHANAN, INGERSOLL & ROONEY PC, POST OFFICE BOX 1404, ALEXANDRIA, VA, 22313-1404, US

(73) Assignee: PRECISE BIOMETRICS AB, Lund (SE)

(21) Appl. No.: 11/795,816

(22) PCT Filed: Jan. 26, 2006
(86) PCT No.: PCT/SE06/00111

§ 371 Date: Nov. 13, 2007

Related U.S. Application Data
(60) Provisional application No. 60/673,365, filed on Apr. 21, 2005.

(30) Foreign Application Priority Data
Jan. 31, 2005 (SE) 0500233-2

(51) Int. Cl. G06K 9/00

(52) U.S. Cl. 382/124

(57) ABSTRACT

A fingerprint sample input apparatus, a fingerprint verification device, a method for aligning fingerprint samples, and a method for fingerprint verification are disclosed. The fingerprint sample input apparatus comprises fingerprint reader, receiver for public part of fingerprint template, alignment matcher, matrix generator, and transmitter. The fingerprint verification device comprises memory, transmitter, receiver, processor, matrix comparator, and threshold comparator. The method for aligning fingerprint sample comprises reading fingerprint sample, receiving a public part of fingerprint template, searching for and determining a matching position between the sample and template, generating an aligned spectral data matrix, and sending it to a fingerprint verification device. The method for fingerprint verification comprises sending a public part of template, receiving an aligned spectral data matrix, determining matrix difference between a spectral template matrix and the aligned spectral data matrix, comparing the matrix difference with a threshold, and outputting a result.

### TECHNICAL FIELD

The present inventive concept relates to a fingerprint sample input apparatus, a fingerprint verification device, a method for aligning fingerprint samples, and a method for fingerprint verification.

### BACKGROUND OF INVENTION

The demand for a high security access solutions increases every day, and due to this the demand for faster and more user-friendly technical access solutions increases as well.

One well-known technique for secure access is the fingerprint verification technique. The main idea of this technique is to enroll a fingerprint sample from a user, preferably digitally, and thereafter compare this with a prestored template. If the comparison result is positive access is granted, otherwise access is denied.

This may seem simple, but there are a number of difficulties. Two main difficulties are to make sure that the template is well protected and to make a reliable comparison.

The template is to be seen as a digital identification for the user, and hence if this is lost, the risk that someone abuse it is apparent. Therefore, a well protected template, physically, or digitally, is a prerequisite to a secure comparison.

There are three main comparison methods for finger-prints: pattern comparison, minutiae comparison and spectral data comparison. The first method, pattern comparison, comprises, in general terms, comparing sub-areas of the input fingerprint with the stored template. Minutiae comparison means, briefly, finding characteristic points in the input fingerprint, and comparing these with pre-stored minutiae points from the template. The third method, spectral data comparison, consists of subdividing the enrolled fingerprint into a number of fingerprint sub-images, and thereafter calculate a number of spectral parameters for each sub-image, for example, direction, which could be calculated as the mean direction of the fingerprint ridges in the sub-image, frequency, which could be calculated as the mean distance between two consecutive fingerprint ridges in the sub-image, and phase, which could be calculated as a phase offset of the fingerprint ridges in the sub-image.

In order to overcome these two difficulties several smart card systems for fingerprint verification have been developed. One common smart card used in one of the most common systems, can be described as a card in the size of a credit card, with a built-in processor, a memory and some kind of communication interface. In addition to the smart card, the system comprises an external fingerprint reader.

The procedure of such a smart card system is that a person presents his or her fingerprint on the external fingerprint reader. Thereafter, the fingerprint is transferred to the smart card, where the input fingerprint is compared with a template stored in the smart card memory, and depending of the comparison a comparison answer is output. So far, the comparison in such a smart card system has been made according to the pattern comparison or minutiae comparison method.

The patent application WO 2004/015615 “Pattern-based interchange format” describes a format for representing and calculating the spectral data parameters described above.

The Master's Thesis “Spectral Fingerprint Matching” (2004:E40) by Magnus Wennergren at Lund Unstitute of Technology describes a general implementation of a spectral data comparison method.

However, different methods have different advantages and several considerations have to be taken into account in order to achieve a feasible secure solution using spectral data comparison. Therefore, there is a need for a secure solution using spectral data comparison.

### SUMMARY OF INVENTION

An object of the present inventive concept is therefore to provide a secure solution using spectral data comparison for fingerprint verification.

The above object is provided according to a first aspect of the present inventive concept by a fingerprint sample input apparatus comprising a fingerprint reader arranged to read a fingerprint sample; a receiver arranged to receive a public part of a fingerprint template; an alignment matcher arranged to determine a rotation value and a translation value from said public part of said fingerprint template and said fingerprint sample; a matrix generator arranged to determine an aligned spectral data matrix from said translation value, said rotation value and said fingerprint sample; and a transmitter arranged to send said aligned spectral data matrix to a fingerprint verification device.

An advantage of this first aspect is that the processing time may be reduced in the built-in processor on the fingerprint verification device, due to the pre-process of the fingerprint sample.

Another advantage of this first aspect is that the spectral data matrix demands less memory than the fingerprint sample.

In this first aspect of the fingerprint sample input apparatus said alignment matcher may be arranged to output an interruption signal.

An advantage of this is that the process may be aborted in this early stage, and hence save power in the fingerprint verification device.

Another advantage of this is that an indication may be sent to the user to place his finger on the fingerprint reader in another way.

Yet another advantage of this is, when the fingerprint verification device may be arranged to provide a certain limited number of consecutive mismatches before being locked, and in order not to risk an unnecessary locking of the fingerprint verification device, due to temporary poor fingerprint sample input conditions, a fingerprint sample of unacceptable quality may be aborted already at this stage, and thereby avoiding a most probable mismatch.

The above object is provided according to a second aspect of the present inventive concept by a fingerprint verification device comprising a memory arranged to store a spectral template matrix and a public part of a fingerprint template; a transmitter arranged to send said public part of said fingerprint template to a fingerprint sample input apparatus; a receiver arranged to receive an aligned spectral data matrix from said fingerprint sample input apparatus; a processor arranged to determine a spectral comparison output from said spectral template matrix and said aligned spectral data matrix, comprising a matrix comparator arranged to compare said aligned spectral data matrix with said spectral template matrix and to output a comparison value; and a threshold comparator arranged to compare said comparison value with a comparison threshold and to output a comparison result; and an output of said comparison result.

An advantage of this second aspect is that the requirements on memory capacity is lower, since the spectral template matrix may be stored efficiently, due to the fact that a substantial part of the calculations has been made in the fingerprint sample input apparatus.

Another advantage of this second aspect is that the processor may have a lower capacity, since the comparison between the aligned spectral data matrix and the spectral template matrix may be made efficiently.

The matrix comparator may comprise a matrix subtractor arranged to subtract said aligned spectral data matrix with said spectral template matrix to a difference matrix, and a matrix summarizer arranged to summarize said difference matrix.

An advantage of this is that subtraction and addition require less calculation power and time, thus implying a more efficient and faster comparation. Another advantage is that specialized integrated circuits for matrix subtraction and matrix summation may be used in order to achieve an efficient system.

The fingerprint verification device may comprise a matrix offset changer arranged to add an offset to said difference matrix.

An advantage of this is that a specialized matrix offset changer may be used in order to achieve a more efficient system by avoiding negative numbers, and thus an improved representation of values.

Another advantage of this is that the representation of the data in the difference matrix may be stored in a more efficient way.

The fingerprint verification device may comprise a matrix weighter arranged to weight said difference matrix according to a weight matrix.

An advantage of this is that the importance of different elements may be weightened.

Said matrix comparator may comprise a score generator arranged to determine a score for each element of the difference matrix.

An advantage of this is that the comparison value, indicating the correspondence between the spectral data matrix and the spectral template matrix, may be calculated according to a point system, in which, for example, a sufficient match generates an increase in the total score, an insufficient match generates a decrease in the total score, and if any of the corresponding elements in the spectral data matrix and spectral template matrix is undefined the total score remains.

The above object is provided according to a third aspect of the present inventive concept by a method for aligning fingerprint sample comprising the steps of: reading a fingerprint sample; receiving a public part of a fingerprint template; searching for a matching translation and a matching rotation between said fingerprint sample and said public part of fingerprint template; determining a rotation value for said matching rotation and a translation value for said matching translation; generating an aligned spectral data matrix from said translation value, said rotation value, and said fingerprint-sample; and sending said aligned spectral data matrix to a fingerprint verification device.

An advantage of this third aspect of the inventive concept is that there may be no demands for alignment on the fingerprint verification device.

Another advantage of this third aspect of the inventive concept is that the fingerprint sample may be preprocessed into a spectral data matrix, which may demand less memory and may be easily compared with a spectral template matrix in the fingerprint verification device.

Said searching for matching translation and rotation may comprise comparing, for a plurality of translations and rotations, images of said fingerprint sample and said public part of fingerprint template.

An advantage of this is that a plurality of versions of the fingerprint sample with different rotation and translation values may be calculated by the fingerprint sample input apparatus as soon as the fingerprint is read. Thereafter, when the public part of the fingerprint template is received, this public part of the finger print template may be compared to this plurality of versions without being reconfigured according to different rotation and translation values. This may result in a lower-matching time, since the calculation of the different versions may start as soon as the fingerprint is read.

Said searching for matching translation and rotation may comprise comparing, for a plurality of translations and rotations, transforms of said fingerprint sample and said public part of fingerprint template.

An advantage with this third aspect of the present inventive concept is that, if the comparison of images described above is uncertain, the different versions and the public part of the fingerprint template may be transformed, for example Fourier transformed, and thereafter may be compared with each other again in order achieve a more reliable result.

Another advantage of this is that a comparison of untransformed images and a comparison of transformed images are made simultaneously, and thereafter may a total match estimation be made with the two sets of comparisons.

Said searching for matching translation and rotation may comprise comparing, for a plurality of translations and rotations, determined minutiae points of said fingerprint sample and said public part of fingerprint template.

An advantage of this is that, if any of the comparisons, or combinations of comparisons, described above is uncertain, minuiae points may be used in order achieve a more reliable result.

The method may further comprise the steps of: determining if any match is found; and ending the method if no match is found.

An advantage with this is that the process may be aborted if no match is found, and hence save further unnecessary computations.

Another advantage with this is that an indication may be sent to the user to place his finger on the fingerprint reader in another way.

The step of generating an aligned spectral data matrix may comprise: adjusting said fingerprint sample according to determined rotation and translation values; dividing said fingerprint sample into a number of elements of a matrix; transforming each of said elements into frequency domain to form a transform matrix; and assigning a set of parameter values to each element of said aligned spectral data matrix corresponding to said transform matrix.

The step of generating an aligned spectral data matrix may comprise: transforming said fingerprint sample into frequency domain; dividing said transformed fingerprint sample into a number of elements of a matrix to form a transform matrix; adjusting said transform matrix according to determined rotation and translation values; and assigning a set of parameter values to each element of said aligned spectral data matrix corresponding to said adjusted transform matrix.

The step of generating an aligned spectral data matrix may comprise: dividing said fingerprint sample into a number of elements of a matrix to form a fingerprint sample matrix; adjusting said fingerprint sample matrix according to determined rotation and translation values; transforming said adjusted fingerprint sample matrix into frequency domain; and assigning a set of parameter values to each element of said aligned spectral data matrix corresponding to said transformed adjusted fingerprint sample matrix.

The step of generating an aligned spectral data matrix may comprise: adjusting said fingerprint sample according to determined rotation and translation values; transforming said adjusted fingerprint sample into frequency domain; dividing said transformed adjusted fingerprint sample into a number of elements of a matrix to form a transformed adjusted fingerprint sample matrix; and assigning a set of parameter values to each element of said aligned spectral data matrix corresponding to said transformed adjusted fingerprint sample matrix.

The step of generating an aligned spectral data matrix may comprise: transforming said fingerprint sample into frequency domain; adjusting said transformed fingerprint sample according to determined rotation and translation values; dividing said adjusted transformed fingerprint sample into a number of elements of a matrix to form a transformed adjusted fingerprint sample matrix; and assigning a set of parameter values to each element of said aligned spectral data matrix corresponding to said transformed adjusted fingerprint sample matrix.

The step of generating an aligned spectral data matrix may comprise: dividing said fingerprint sample into a number of elements of a matrix to form a fingerprint sample matrix; transforming said fingerprint sample matrix into frequency domain; adjusting said transformed fingerprint sample matrix according to determined rotation and translation values; and assigning a set of parameter values to each element of said aligned spectral data matrix corresponding to said adjusted transformed fingerprint sample matrix.

An advantage of this is that each element of the aligned spectral data matrix contains a set of invariant features.

Another advantage of this is that said spectral data matrix demands low memory capacity.

The above object is provided according to a fourth aspect of the present inventive concept by a method for fingerprint verification comprising the steps of: sending a public part of a fingerprint template; receiving, as a response to said sending of said public part of said fingerprint template, an aligned spectral data matrix corresponding to a fingerprint sample; determining a matrix difference measure between a spectral template matrix corresponding to a fingerprint template and said aligned spectral data matrix; comparing said matrix difference measure with a threshold; and providing an output dependent on said comparison.

An advantage of this is that the only part of the template, which may be a too small part for abusement, may be made public.

Another advantage of this is that an aligned spectral data matrix is received, which makes only subtraction and addition operations necessary in the fingerprint verification device.

Said step of determining a difference may comprise the steps of: calculating, for a parameter, an element difference measure between each corresponding element of said aligned spectral data matrix and said spectral template matrix; aggregating said element difference measures; and assigning said matrix difference measure to be said aggregated element difference measures.

An advantage of this is that said differences may be calculated by only using subtraction, which implies few processor operations.

Said parameter may be phase, frequency, or direction, or any complex combination thereof.

An advantage of this is that the phase, frequency and direction may easily be calculated from the transformation matrix.

Another advantage of this is that there may be sufficiently low correlation between phase, frequency and direction.

The method may further comprise setting said element difference measure to null when either a element value of said aligned spectral matrix, or of said template matrix, or both, is uncertain.

An advantage of this is that the uncertainty reduction of the verification may be divided into two steps, wherein the first step may be the uncertainty at element level, as described above, and the second step is the total level, wherein the sum is compared to a threshold.

The method may further comprise weighting said element difference measures depending on respective element position.

An advantage of this is that areas where the uncertainty is empirically found to be higher is weighted lower than areas where the uncertainty is empirically found to be lower.

The method may further comprise adding an offset to said element difference measures, wherein said offset being essentially a half of a dynamic range of said difference measures.

An advantage of this is that the difference measures may be stored in a more memory efficient way. Said step of comparing said matrix difference with a threshold may comprise comparing a first difference parameter with a first threshold, and if said comparison indicates more difference than said first threshold, comparing a second difference parameter with a second threshold; or if said comparison indicates less difference than said first threshold, indicating said fingerprint sample as verified.

An advantage of this that a faster verification procedure may be achieved.

Said step of comparing said matrix difference with a threshold may further comprise, if said comparison between said second difference parameter and said second threshold indicates less difference than said second threshold, calculating a joint difference value from said first and second parameters; comparing said joint difference value with a third threshold; and if said comparison of said joint difference value with said third threshold indicates less difference than said third threshold, indicating said fingerprint sample as verified.

An advantage of this is that thresholds in several dimensions may be used.

### BRIEF DESCRIPTION OF THE DRAWINGS

The above, as well as additional objects, features and advantages of the present inventive concept, will be better understood through the following illustrative and non-limiting detailed description of preferred embodiments of the present inventive concept, with reference to the appended drawings, wherein:

FIG. 1 schematically shows a fingerprint input apparatus;

FIG. 2 schematically shows a fingerprint verification device;

FIG. 3 is a flow chart illustrating a method for aligning fingerprint sample;

FIG. 4 is a flow chart illustrating a method for fingerprint verification;

FIG. 5 is a flow chart illustrating a procedure of determining matrix difference; and

FIG. 6 is a flow chart illustrating a procedure for incremental refinement of fingerprint verification.

### DETAILED DESCRIPTION OF PREFERRED EMBODIMENTS

FIG. 1 schematically illustrates a fingerprint sample input apparatus according to an embodiment of the present inventive concept. It should be noted that the parts not contributing to the core of the inventive concept are left out not to obscure the features of the present inventive concept.

The fingerprint sample input apparatus 100 comprises a fingerprint reader 101 for reading a fingerprint sample. The fingerprint reader can be integrated with the rest of the fingerprint sample input apparatus, or be connected thereto as a separate unit. The fingerprint reader is preferably a sensor of capacitive type, but it can also be optical, thermal or pressure-sensitive, or any other commercially available fingerprint sensor.

The fingerprint sample input apparatus further comprises a receiver 102 for receiving a public part of a fingerprint template. The receiver 102 can be arranged to receive the public part of the fingerprint template via one or several metal contacts, or wireless via radio signals.

The fingerprint sample read in the fingerprint reader 101 and the public part of the fingerprint template received by the receiver 102 are transferred to an alignment matcher 103. The alignment matcher 103, which can be a processor, can be arranged to find a proper alignment between the fingerprint sample and the public part of the fingerprint template and to output a translation value and a rotation value describing this proper alignment. If no proper alignment is found, the output can be an interruption signal.

The translation and rotation values determined in the alignment matcher, and the fingerprint sample are transferred to a matrix generator 105. The matrix generator 105 can also be a processor, and a most convenient way is to include the alignment matcher 103 and the matrix generator 105 in the same processor. Further, the matrix generator can be arranged to generate an aligned spectral data matrix of the fingerprint sample with respect to the received rotation value and the received translation value.

The aligned spectral data matrix is transferred to a transmitter 106. The transmitter 106 can be arranged to transmit the public part of the fingerprint template via one or several metal contacts, or wireless via e.g. radio signals.

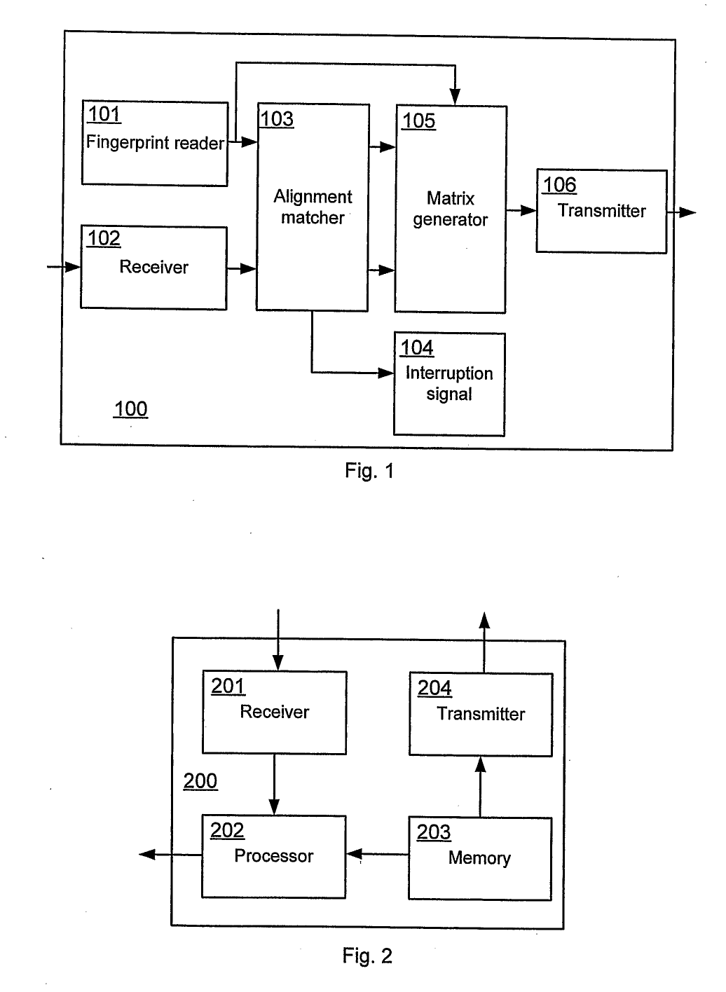

FIG. 2 schematically illustrates a fingerprint verification device 200 according to an embodiment of the present inventive concept. It should be noted that the parts not contributing to the core of the inventive concept are left out not to obscure the features of the present inventive concept.

The fingerprint verification device comprises a receiver 201, which can be arranged to receive the spectral data matrix via one or several metal contacts, or wireless via e.g. radio signals.

The spectral data matrix is transferred to a processor 202. The processor 202 is also arranged to receive a spectral template matrix from a memory 203. Further, the processor is arranged to compare the spectral data matrix and the spectral template matrix and to output an answer of this comparison to internal applications of the fingerprint verification device, or to e.g the fingerprint sample input apparatus 100, or one or several external units demanding user verification, such as a control unit of an entrance door (not shown).

Instead of transmitting an answer of said comparison to the fingerprint sample input apparatus, the answer could be transferred internally on the card to, for example, open up access to locked data in the memory, and thereby, for example, achieve access to a decrypting key.

The memory 203 is arranged to store the public part of the fingerprint, the spectral template matrix, as well as software which, for example, controls the comparison of the spectral data matrix and the spectral template matrix.

The fingerprint verification device further comprises a transmitter 204, which can be arranged to transmit the public part of the fingerprint template via one or several metal contacts, or wireless via radio signals.

The fingerprint verification device can most conveniently be a smart card, but also another device having a processor, memory, receiver and transmitter, such as a mobile communication terminal, can be used as a fingerprint verification device.

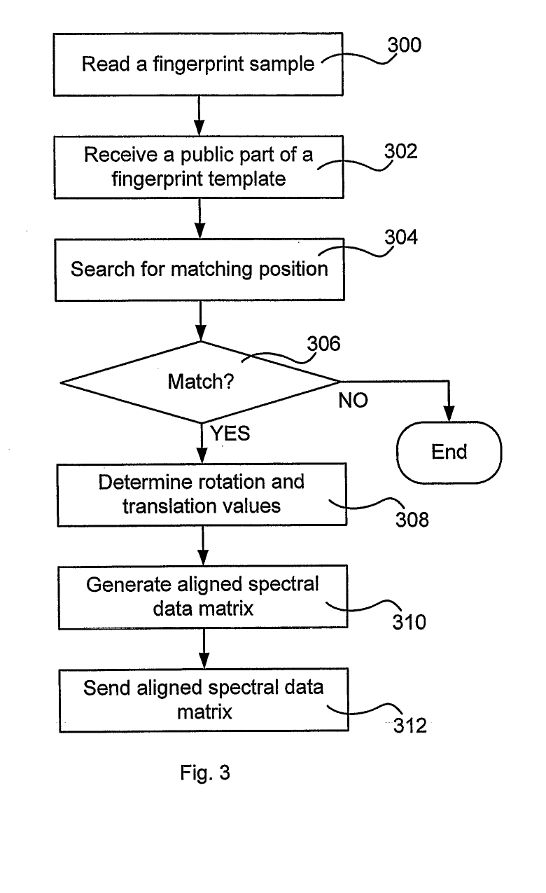

FIG. 3 is a flow chart illustrating a method for aligning fingerprint sample. In a fingerprint reading step 300, a fingerprint sample is read, e.g. from a fingerprint scanner or a fingerprint reader. There are a plurality of available fingerprint reading techniques using e.g. conductivity, capacity, thermal, or optical image of the finger from which the fingerprint sample is to be taken. In a template receiving step 302, a public part of a fingerprint template is received. A fingerprint template and the public data is stored on a memory, e.g. on a smartcard, or in a mobile telephone, preferably on the subscriber identity module, that cannot be externally accessed, and only a public part of the fingerprint template is accessible. The fingerprint reading step 300 and the template receiving step 302 can be performed in any order, or in parallel.

A matching position, i.e. a matching rotation and translation, between the received public part of the fingerprint template and the fingerprint sample, is performed in a matching position searching step 304. The matching can be performed on images of the fingerprint sample and the public part of the fingerprint template, where a plurality of rotations and translations are tested for match. Further, it is possible, in a similar way, to perform matching based on transforms of the fingerprint sample and the public part of the fingerprint template, or to perform matching based on minutiae points of the fingerprint sample and the public part of the fingerprint template. Optionally, if no match is found, it is determined in a match check step 306 that the method should end to save computing capacity, or to reduce the risk of unnecessary locking the fingerprint verification device because of too many consecutive false matches, as described above. When a match is found, a rotation value and a translation value is determined in a rotation and translation determination step 308. The actual translation can be determined since the position of the public part of the fingerprint template in relation to the fingerprint template is known. From the determined rotation and translation values, an aligned spectral data matrix is generated in an aligned spectral data matrix generation step 310. To generate the aligned spectral data matrix, in brief, adjusting of the position, dividing into a matrix, transforming into frequency domain, and assigning parameters to the aligned spectral data matrix are performed. Implementation of adjusting of the position, dividing into a matrix, and transforming into frequency domain can be performed in a plurality of orders, each order with advantages and drawbacks for the implementation.

An example is to adjust the fingerprint sample according to determined rotation and translation values, divide the adjusted fingerprint sample into a number of elements of a matrix, and transforming each of said elements into frequency domain. From the transformed matrix, a set of parameter values, e.g. where each parameter value is represented by a byte, is assigned to each element of the aligned spectral data matrix. The parameters can be frequency, phase, and/or direction.

Another example is to transform the fingerprint sample into frequency domain, dividing the transformed fingerprint sample into a number of elements of a matrix, and adjusting each of said elements according to determined rotation and translation values. From the adjusted matrix, a set of parameter values, e.g. where each parameter value is represented by a byte, is assigned to each element of the aligned spectral data matrix. The parameters can be frequency, phase, and/or direction.

The aligned spectral data matrix is sent to a fingerprint verification device in a sending step 312.

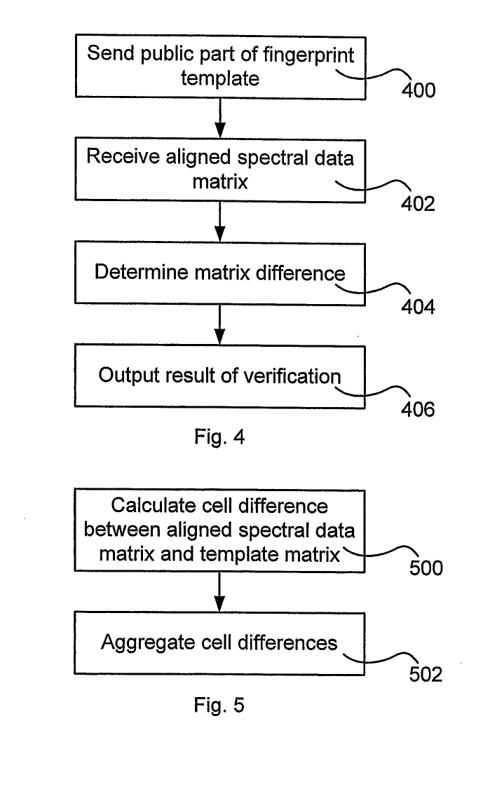

FIG. 4 is a flow chart illustrating a method for fingerprint verification. In a sending step 400, a public part of a fingerprint template is sent, e.g. to a fingerprint reading device. As a response to the sent public part of the fingerprint template, an aligned spectral data matrix corresponding to a fingerprint sample is received in an aligned spectral data matrix step 402. In a matrix difference determination step 404, a matrix difference measure between a spectral template matrix and the received aligned spectral data matrix is determined. The determination of matrix difference measure can comprise elementwise calculation of differences for one or more parameters. The parameters can be frequency, phase, and/or direction. For elements, where the parameter value is undefined or considered uncertain in either the spectral template matrix, or the aligned spectral data matrix, or both, the difference measure can be assigned a null value. The difference measures can be weighted depending on the position of the actual element, or on a confidence degree of the parameter values of the actual element. An offset can be added to the difference measures to facilitate the representation of the values of the difference measures, i.e. avoiding negative numbers. For this, an offset being essentially half of the dynamic range of the difference measures can be a feasible implementation. For example, if the difference measure values are represented by a byte, an offset of 127 can be feasible.

FIG. 5 is a flow chart illustrating a procedure of determining matrix difference according to an embodiment of the present inventive concept. Differences between each elements of the spectral template matrix and the aligned spectral data matrix are calculated in a element difference calculation step 500. Weighting and assigning of offset and null values, as described above in connection with FIG. 4, can be applied. The calculated element differences are then aggregated in a element difference aggregation step 502 to determine a matrix difference. The matrix difference can be a multidimensional value.

Returning to FIG. 4, an output of a fingerprint verification is provided in a result output step 406. The result can be determined in a plurality of ways, each depending on certainty requirements, speed requirements, and available calculation power.

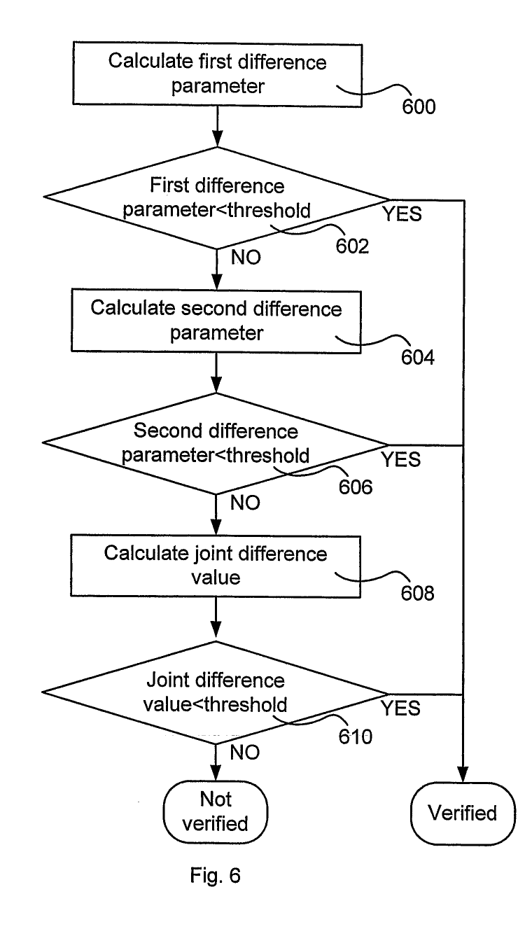

FIG. 6 is a flow chart illustrating a procedure for incremental refinement of fingerprint verification according to one embodiment of the present inventive concept. A matrix difference is calculated for a first parameter of the spectral matrices, e.g. direction, in a first difference parameter calculation step 600. The first difference parameter is compared with a threshold in a first difference parameter comparison step 602, and if the first difference parameter indicates less difference, i.e. better match, than the threshold, the result is set to be that the fingerprint is verified. If the first difference parameter indicates more difference, i.e. less match, than the threshold, a second difference parameter is calculated, e.g. frequency, in a second difference parameter calculation step 604. The second difference parameter is compared with a threshold in a second difference parameter comparison step 606, and if the second difference parameter indicates less difference, i.e. better match, than the threshold, the result is set to be that the fingerprint is verified. If the second difference parameter indicates more difference, i.e. less match, than the threshold, a joint difference value is calculated from the first and second difference parameters in a joint difference value calculation step 608, e.g. regarding the first and second difference parameters as perpendicular vectors and assigning the absolute value of the sum of the vectors to get the joint difference value. The joint difference value is compared with a threshold in a joint difference value comparison step 610, and if the joint difference value indicates less difference, i.e. better match, than the threshold, the result is set to be that the fingerprint is verified. Otherwise, the fingerprint is considered as not verified. This way, if a good match is determined with only one parameter, a lot of calculation power is saved, but an incremental refinement of the verification is possible when needed. Instead of considering the fingerprint as not verified, after the last step 610 described above, further refinement steps (not shown) are possible, e.g. considering a third parameter, e.g. phase, a vector sum of further parameters, and/or starting a match procedure using minutiae points. More than one threshold value for each difference parameter comparison, i.e. setting upper and lower bounds for further refinement, can be used to determine if further refinements should be made, or if the fingerprint should be considered as not verified.

The result output can be used for providing internal access in the fingerprint verification device, or be sent to the fingerprint reading device for further processing of the verification result, e.g. to provide access to an application, location, system, etc., or be sent directly to an access control device, e.g. a door.

Communication, as sending and receiving, as described above, can be wired and/or wireless. For wired communication, connector means need to be provided, and for wireless communication, wireless interfaces, such as radio or light, need to be provided.

Producing the spectral data matrix can be performed in a number of ways, each with their benefits in certain implementations. The aligned spectral data matrix can be produced in a fingerprint sample input apparatus, a fingerprint verification device, or any means connected to these. The production of the aligned spectral data matrix can also be distributed among these.

The step of generating an aligned spectral data matrix can comprise: adjusting said fingerprint sample according to determined rotation and translation values; dividing said fingerprint sample into a number of elements of a matrix; transforming each of said elements into frequency domain to form a transform matrix; and assigning a set of parameter values to each element of said aligned spectral data matrix corresponding to said transform matrix.

The step of generating an aligned spectral data matrix can comprise:

transforming said fingerprint sample into frequency domain;

dividing said transformed fingerprint sample into a number of elements of a matrix to form a transform matrix;

adjusting transform matrix according to determined rotation and translation values; and

assigning a set of parameter values to each element of said aligned spectral data matrix corresponding to said adjusted transform matrix.

The step of generating an aligned spectral data matrix can comprise:

dividing said fingerprint sample into a number of elements of a matrix to form a fingerprint sample matrix;

adjusting said fingerprint sample matrix according to determined rotation and translation values;

transforming said adjusted fingerprint sample matrix into frequency domain; and

assigning a set of parameter values to each element of said aligned spectral data matrix corresponding to said transformed adjusted fingerprint sample matrix.

The step of generating an aligned spectral data matrix can comprise:

adjusting said fingerprint sample according to determined rotation and translation values;

transforming said adjusted fingerprint sample into frequency domain;

dividing said transformed adjusted fingerprint sample into a number of elements of a matrix to form a transformed adjusted fingerprint sample matrix; and

assigning a set of parameter values to each element of said aligned spectral data matrix corresponding to said transformed adjusted fingerprint sample matrix.

The step of generating an aligned spectral data matrix can comprise:

transforming said fingerprint sample into frequency domain;

adjusting said transformed fingerprint sample according to determined rotation and translation values;

dividing said adjusted transformed fingerprint sample into a number of elements of a matrix to form a transformed adjusted fingerprint sample matrix; and

assigning a set of parameter values to each element of said aligned spectral data matrix corresponding to said transformed adjusted fingerprint sample matrix.

The step of generating an aligned spectral data matrix can comprise:

dividing said fingerprint sample into a number of elements of a matrix to form a fingerprint sample matrix;

transforming said fingerprint sample matrix into frequency domain;

adjusting said transformed fingerprint sample matrix according to determined rotation and translation values; and

assigning a set of parameter values to each element of said aligned spectral data matrix corresponding to said adjusted transformed fingerprint sample matrix.

According to an alternative embodiment of the inventive concept, there is provided a fingerprint sample input apparatus comprising a fingerprint reader arranged to read a fingerprint sample;

a matrix generator arranged to determine an spectral data matrix from said said fingerprint sample; and

a transmitter arranged to send said spectral data matrix to a fingerprint verification device.

Said matrix generator can be arranged to output an interruption signal.

According to an alternative embodiment of the inventive concept, there is provided a fingerprint verification device comprising

a memory arranged to store a spectral template matrix of a fingerprint template;

a receiver arranged to receive a spectral data matrix from a fingerprint sample input apparatus;

a processor arranged to determine a spectral comparison output from said spectral template matrix and said spectral data matrix, comprising

a matrix comparator arranged to compare said spectral data matrix with said spectral template matrix and to output a comparison value; and

a threshold comparator arranged to compare said comparison value with a comparison threshold and to output a comparison result; and

an output of said comparison result.

An embodiment of the fingerprint verification device can be provided, wherein said matrix comparator comprises

a matrix subtractor arranged to subtract said spectral data matrix with said spectral template matrix to a difference matrix, and a matrix summarizer arranged to summarize said difference matrix.

An embodiment of the fingerprint verification device can be provided, comprising a matrix offset changer arranged to add an offset to said difference matrix.

An embodiment of the fingerprint verification device can be provided, comprising a matrix weighter arranged to weight said difference matrix according to a weight matrix.

An embodiment of the fingerprint verification device can be provided, wherein said matrix comparator comprises a score generator arranged to determine a score for each element of the difference matrix.

An embodiment of the fingerprint verification device can be provided, further comprising a spectral matrix aligner, wherein said spectral matrix aligner comprises an alignment matcher arranged to determine a rotation value and a translation value from at least a part of said spectral template matrix and said spectral data matrix;

a matrix generator arranged to determine an aligned spectral data matrix from said translation value, said rotation value and said fingerprint sample. Said aligned spectral data matrix is used in said matrix comparator for comparison with said spectral template matrix.

The above embodiments of the fingerprint verification device can be provided in any combination.

According to an alternative embodiment of the inventive concept, there is provided a method for providing fingerprint sample comprising the steps of:

reading a fingerprint sample;

generating a spectral data matrix from said fingerprint sample; and

sending said spectral data matrix to a fingerprint verification device.

According to an alternative embodiment of the inventive concept, there is provided a method for fingerprint verification comprising the steps of:

receiving a spectral data matrix corresponding to a fingerprint sample;

determining a matrix difference measure between a spectral template matrix corresponding to a fingerprint template and said spectral data matrix;

comparing said matrix difference measure with a threshold; and

providing an output dependent on said comparison.

An embodiment of the method is provided, wherein said step of determining a difference further comprises the steps of:

calculating, for a parameter, an element difference measure between each corresponding element of said spectral data matrix and said spectral template matrix;

aggregating said element difference measures; and

assigning said matrix difference measure to be said aggregated element difference measures.

An embodiment of the method is provided, wherein said parameter is phase, frequency, or direction, or any complex combination thereof.

The method can further comprise setting said element difference measure to null when either an element value of said spectral matrix, or of said template matrix, or both, is uncertain.

The method can further comprise weighting said element difference measures depending on respective element position.

The method can further comprise adding an offset to said element difference measures, wherein said offset being essentially a half of a dynamic range of said difference measures.

An embodiment of the method can be provided, wherein said step of comparing said matrix difference with a threshold comprises comparing a first difference parameter with a first threshold, and

if said comparison indicates more difference than said first threshold, comparing a second difference parameter with a second threshold; or

if said comparison indicates less difference than said first threshold, indicating said fingerprint sample as verified.

An embodiment of the method can be provided, wherein said step of comparing said matrix difference with a threshold further comprises, if said comparison between said second parameter and said second threshold indicates less difference than said second threshold,

calculating a joint difference value from said first and second parameters;

comparing said joint difference value with a third threshold; and

if said comparison of said joint difference value with said third threshold indicates less difference than said third threshold, indicating said fingerprint sample as verified.

The method can further comprise searching for matching translation and rotation of said spectral data matrix by comparing, for a plurality of translations and rotations, said spectral data matrix and at least a part of said spectral template.

The method can further comprise the steps of:

determining if any match is found; and

ending the method if no match is found.

The above embodiments of the fingerprint verification method can be provided in any combination.

According to an alternative embodiment of the inventive concept, there is provided a fingerprint sample input apparatus comprising

a fingerprint reader arranged to read a fingerprint sample; and

a transmitter arranged to send said fingerprint sample to a fingerprint verification device.

According to an alternative embodiment of the inventive concept, there is provided a fingerprint verification device comprising

a memory arranged to store a spectral template matrix of a fingerprint template;

a receiver arranged to receive a fingerprint sample from a fingerprint sample input apparatus;

a matrix generator arranged to determine a spectral data matrix from said said fingerprint sample;

a processor arranged to determine a spectral comparison output from said spectral template matrix and said spectral data matrix, comprising

a matrix comparator arranged to compare said spectral data matrix with said spectral template matrix and to output a comparison value; and

a threshold comparator arranged to compare said comparison value with a comparison threshold and to output a comparison result; and

an output of said comparison result.

An embodiment of the fingerprint verification device is provided, wherein said matrix comparator comprises a matrix subtractor arranged to subtract said spectral data matrix with said spectral template matrix to a difference matrix, and a matrix summarizer arranged to summarize said difference matrix.

An embodiment of the fingerprint verification device is provided, comprising a matrix offset changer arranged to add an offset to said difference matrix.

An embodiment of the fingerprint verification device is provided, comprising a matrix weighter arranged to weight said difference matrix according to a weight matrix.

An embodiment of the fingerprint verification device is provided, wherein said matrix comparator comprises a score generator arranged to determine a score for each element of the difference matrix.

An embodiment of the fingerprint verification device is provided, further comprising a spectral matrix aligner, wherein said spectral matrix aligner comprises

an alignment matcher arranged to determine a rotation value and a translation value from at least a part of said spectral template matrix and said spectral data matrix;

a matrix generator arranged to determine an aligned spectral data matrix from said translation value, said rotation value and said fingerprint sample. Said aligned spectral data matrix is used in said matrix comparator for comparison with said spectral template matrix.

The above embodiments of the fingerprint verification device can be provided in any combination.

According to an alternative embodiment of the inventive concept, there is provided a method for providing fingerprint sample comprising the steps of:

reading a fingerprint sample;

sending said fingerprint sample to a fingerprint verification device.

According to an alternative embodiment of the inventive concept, there is provided a method for fingerprint verification comprising the steps of:

receiving a fingerprint sample;

generating a spectral data matrix from said fingerprint sample; and

determining a matrix difference measure between a spectral template matrix corresponding to a fingerprint template and said spectral data matrix;

comparing said matrix difference measure with a threshold; and

providing an output dependent on said comparison.

An embodiment of the method can be provided, wherein said step of determining a difference further comprises the steps of:

calculating, for a parameter, an element difference measure between each corresponding element of said spectral data matrix and said spectral template matrix;

aggregating said element difference measures; and

assigning said matrix difference measure to be said aggregated element difference measures.

An embodiment of the method can be provided, wherein said parameter is phase, frequency, or direction, or any complex combination thereof.

The method can further comprise setting said element difference measure to null when either an element value of said spectral matrix, or of said template matrix, or both, is uncertain.

The method can further comprise weighting said element difference measures depending on respective element position.

The method can further comprise adding an offset to said element difference measures, wherein said offset being essentially a half of a dynamic range of said difference measures.

An embodiment of the method is provided, wherein said step of comparing said matrix difference with a threshold comprises comparing a first difference parameter with a first threshold, and

if said comparison indicates more difference than said first threshold, comparing a second difference parameter with a second threshold; or

if said comparison indicates less difference than said first threshold, indicating said fingerprint sample as verified.

An embodiment of the method is provided, wherein said step of comparing said matrix difference with a threshold further comprises, if said comparison between said second parameter and said second threshold indicates less difference than said second threshold, calculating a joint difference value from said first and second parameters;

comparing said joint difference value with a third threshold; and

if said comparison of said joint difference value with said third threshold indicates less difference than said third threshold, indicating said fingerprint sample as verified.

The method can further comprise searching for matching translation and rotation of said spectral data matrix by comparing, for a plurality of translations and rotations, said spectral data matrix and at least a part of said spectral template.

The method can further comprise the steps of:

determining if any match is found; and

ending the method if no match is found.

The above embodiments of the fingerprint verification method can be provided in any combination.

According to an embodiment of the inventive concept, there is provided a fingerprint sample input apparatus comprising

a fingerprint reader arranged to read a fingerprint sample;

a receiver arranged to receive a public part of a fingerprint template;

an alignment matcher arranged to determine a rotation value and a translation value from said public part of said fingerprint template and said fingerprint sample;

a data generator arranged to determine an aligned data set from said translation value, said rotation value and said fingerprint sample; and

a transmitter arranged to send said aligned data set to a fingerprint verification device.

An embodiment of the fingerprint sample input apparatus is provided, wherein said alignment matcher is further arranged to output an interruption signal.

The above embodiments of the fingerprint sample input apparatus can be provided in combination.

According to an embodiment of the inventive concept, there is provided a fingerprint verification device comprising

a memory arranged to store a spectral template matrix and a public part of a fingerprint template;

a transmitter arranged to send said public part of said fingerprint template to a fingerprint sample input apparatus;

a receiver arranged to receive an aligned data set from said fingerprint sample input apparatus;

a matrix generator arranged to determine an aligned spectral data matrix from said aligned data set;

a processor arranged to determine a spectral comparison output from said spectral template matrix and said aligned spectral data matrix, comprising

a matrix comparator arranged to compare said aligned spectral data matrix with said spectral template matrix and to output a comparison value; and

a threshold comparator arranged to compare said comparison value with a comparison threshold and to output a comparison result; and

an output for said comparison result.

An embodiment of the fingerprint verification device is provided, wherein said matrix comparator comprising a matrix subtractor arranged to subtract said aligned spectral data matrix with said spectral template matrix to a difference matrix, and a matrix summarizer arranged to summarize said difference matrix.

An embodiment of the fingerprint verification device is provided, comprising a matrix offset changer arranged to add an offset to said difference matrix.

An embodiment of the fingerprint verification device is provided, comprising a matrix weighter arranged to weight said difference matrix according to a weight matrix.

An embodiment of the fingerprint verification device is provided, wherein said matrix comparator comprises a score generator arranged to determine a score for each element of the difference matrix.

The above embodiments of the fingerprint verification device can be provided in any combination.

According to an embodiment of the inventive concept, there is provided a method for aligning fingerprint sample comprising the steps of:

reading a fingerprint sample;

receiving a public part of a fingerprint template;

searching for a matching translation and a matching rotation between said fingerprint sample and said public part of fingerprint template;

determining a rotation value for said matching rotation and a translation value for said matching translation;

generating an aligned data set from said translation value, said rotation value, and said fingerprint sample; and

sending said aligned data set to a fingerprint verification device.

An embodiment of the method is provided, wherein said searching for matching translation and rotation further comprises comparing, for a plurality of translations and rotations, images of said fingerprint sample and said public part of fingerprint template.

An embodiment of the method is provided, wherein said searching for matching translation and rotation further comprises comparing, for a plurality of translations and rotations, determined minutiae points of said fingerprint sample and said public part of fingerprint template.

The method can further comprise the steps of:

determining if any match is found; and

ending the method if no match is found.

An embodiment of the method is provided, wherein the step of generating an aligned data set comprises adjusting said fingerprint sample according to determined rotation and translation values.

The above embodiments of the method for aligning fingerprint sample can be provided in any combination.

According to an embodiment of the inventive concept, there is provided a method for fingerprint verification comprising the steps of:

sending a public part of a fingerprint template;

receiving, as a response to said sending of said public part of said fingerprint template, an aligned data set corresponding to a fingerprint sample;

generating an aligned spectral data matrix from said aligned data set;

determining a matrix difference measure between a spectral template matrix corresponding to a fingerprint template and said aligned spectral data matrix;

comparing said matrix difference measure with a threshold; and

providing an output dependent on said comparison.

An embodiment of the method is provided, wherein said step of determining a difference further comprises the steps of:

calculating, for a parameter, an element difference measure between each corresponding element of said aligned spectral data matrix and said spectral template matrix;

aggregating said element difference measures; and

assigning said matrix difference measure to be said aggregated element difference measures.

An embodiment of the method is provided, wherein said parameter is phase, frequency, or direction, or any complex combination thereof.

An embodiment of the method is provided, further comprising setting said element difference measure to null when either an element value of said aligned spectral matrix, or of said template matrix, or both, is uncertain.

The method can further comprise weighting said element difference measures depending on respective element position.

The method can further comprise adding an offset to said element difference measures, wherein said offset being essentially a half of a dynamic range of said difference measures.

An embodiment of the method is provided, wherein said step of comparing said matrix difference with a threshold comprises comparing a first difference parameter with a first threshold, and

if said comparison indicates more difference than said first threshold, comparing a second difference parameter with a second threshold; or

if said comparison indicates less difference than said first threshold, indicating said fingerprint sample as verified.

An embodiment of the method is provided, wherein said step of comparing said matrix difference with a threshold further comprises, if said comparison between said second parameter and said second threshold indicates less difference than said second threshold,

calculating a joint difference value from said first and second parameters;

comparing said joint difference value with a third threshold; and

if said comparison of said joint difference value with said third threshold indicates less difference than said third threshold, indicating said fingerprint sample as verified.

The above embodiments of the method fingerprint verification can be provided in any combination.

1. A fingerprint sample input apparatus comprising a fingerprint reader arranged to read a fingerprint sample;
a receiver arranged to receive a public part of a fingerprint template;
an alignment matcher arranged to determine a rotation value and a translation value from said public part of said fingerprint template and said fingerprint sample;
a matrix generator arranged to determine an aligned spectral data matrix from said translation value, said rotation value and said fingerprint sample; and
a transmitter arranged to send said aligned spectral data matrix to a fingerprint verification device.

2. The fingerprint sample input apparatus according to claim 1, wherein said alignment matcher is further arranged to output an interruption signal.

3. A fingerprint verification device comprising
a memory arranged to store a spectral template matrix and a public part of a fingerprint template;
a transmitter arranged to send said public part of said fingerprint template to a fingerprint sample input apparatus;
a receiver arranged to receive an aligned spectral data matrix from said fingerprint sample input apparatus;
a processor arranged to determine a spectral comparison output from said spectral template matrix and said aligned spectral data matrix, comprising
a matrix comparator arranged to compare said aligned spectral data matrix with said spectral template matrix and to output a comparison value; and
a threshold comparator arranged to compare said comparison value with a comparison threshold and to output a comparison result; and
an output of said comparison result.

4. The fingerprint verification device according to claim 3, wherein said matrix comparator comprising a matrix subtractor arranged to subtract said aligned spectral data matrix with said spectral template matrix to a difference matrix, and a matrix summarizer arranged to summarize said difference matrix.

5. The fingerprint verification device according to claim 4, comprising a matrix offset changer arranged to add an offset to said difference matrix.

6. The fingerprint verification device according to claim 4, comprising a matrix weighter arranged to weight said difference matrix according to a weight matrix.

7. The fingerprint verification device according to claim 4, wherein said matrix comparator comprises a score generator arranged to determine a score for each element of the difference matrix.

8. A method for aligning fingerprint sample comprising the steps of:
reading a fingerprint sample;
receiving a public part of a fingerprint template;
searching for a matching translation and a matching rotation between said fingerprint sample and said public part of fingerprint template;
determining a rotation value for said matching rotation and a translation value for said matching translation;
generating an aligned spectral data matrix from said translation value, said rotation value, and said fingerprint sample; and
sending said aligned spectral data matrix to a fingerprint verification device.

9. The method according to claim 8, wherein said searching for matching translation and rotation comprises comparing, for a plurality of translations and rotations, images of said fingerprint sample and said public part of fingerprint template.

10. The method according to claim 8, wherein said searching for matching translation and rotation comprises comparing, for a plurality of translations and rotations, transforms of said fingerprint sample and said public part of fingerprint template.

11. The method according to claim 8, wherein said searching for matching translation and rotation comprises comparing, for a plurality of translations and rotations, determined minutiae points of said fingerprint sample and said public part of fingerprint template.

12. The method according to claim 8, further comprising the steps of:
determining if any match is found; and
ending the method if no match is found.

13. The method according to claim 8, wherein the step of generating an aligned spectral data matrix further comprises:
adjusting said fingerprint sample according to determined rotation and translation values;
dividing said adjusted fingerprint sample into a number of elements of a matrix;
transforming each of said elements into frequency domain to form a transform matrix; and
assigning a set of parameter values to each element of said aligned spectral data matrix corresponding to said transform matrix.

14. The method according to claim 8, wherein the step of generating an aligned spectral data matrix further comprises:
transforming said fingerprint sample into frequency domain;
dividing said transformed fingerprint sample into a number of elements of a matrix to form a transform matrix;
adjusting said transform matrix according to determined rotation and translation values; and
assigning a set of parameter values to each element of said aligned spectral data matrix corresponding to said adjusted transform matrix.

15. The method according to claim 8, wherein the step of generating an aligned spectral data matrix further comprises:
dividing said fingerprint sample into a number of elements of a matrix to form a fingerprint sample matrix;
adjusting said fingerprint sample matrix according to determined rotation and translation values;
transforming said adjusted fingerprint sample matrix into frequency domain; and
assigning a set of parameter values to each element of said aligned spectral data matrix corresponding to said transformed adjusted fingerprint sample matrix.

16. The method according to claim 8, wherein the step of generating an aligned spectral data matrix further comprises:
adjusting said fingerprint sample according to determined rotation and translation values;
transforming said adjusted fingerprint sample into frequency domain;
dividing said transformed adjusted fingerprint sample into a number of elements of a matrix to form a transformed adjusted fingerprint sample matrix; and
assigning a set of parameter values to each element of said aligned spectral data matrix corresponding to said transformed adjusted fingerprint sample matrix.

17. The method according to claim 8, wherein the step of generating an aligned spectral data matrix further comprises:
transforming said fingerprint sample into frequency domain;
adjusting said transformed fingerprint sample according to determined rotation and translation values;
dividing said adjusted transformed fingerprint sample into a number of elements of a matrix to form a transformed adjusted fingerprint sample matrix; and
assigning a set of parameter values to each element of said aligned spectral data matrix corresponding to said transformed adjusted fingerprint sample matrix.

18. The method according to claim 8, wherein the step of generating an aligned spectral data matrix further comprises:
dividing said fingerprint sample into a number of elements of a matrix to form a fingerprint sample matrix;
transforming said fingerprint sample matrix into frequency domain;
adjusting said transformed fingerprint sample matrix according to determined rotation and translation values; and
assigning a set of parameter values to each element of said aligned spectral data matrix corresponding to said adjusted transformed fingerprint sample matrix.

19. A method for fingerprint verification comprising the steps of:
sending a public part of a fingerprint template;
receiving, as a response to said sending of said public part of said fingerprint template, an aligned spectral data matrix corresponding to a fingerprint sample;
determining a matrix difference measure between a spectral template matrix corresponding to a fingerprint template and said aligned spectral data matrix;
comparing said matrix difference measure with a threshold; and
providing an output dependent on said comparison.

20. The method according to claim 19, wherein said step of determining a difference further comprises the steps of:
calculating, for a parameter, an element difference measure between each corresponding element of said aligned spectral data matrix and said spectral template matrix;
aggregating said element difference measures; and
assigning said matrix difference measure to be said aggregated element difference measures.

21. The method according to claim 20, wherein said parameter is phase, frequency, or direction, or any complex combination thereof.

22. The method according to claim 20, further comprising setting said element difference measure to null when either an element value of said aligned spectral matrix, or of said template matrix, or both, is uncertain.

23. The method according to claim 20, further comprising weighting said element difference measures depending on respective element position.

24. The method according to claim 20, further comprising adding an offset to said element difference measures, wherein said offset being essentially a half of a dynamic range of said difference measures.

25. The method according to claim 19. wherein said step of comparing said matrix difference with a threshold comprises comparing a first difference parameter with a first threshold, and
if said comparison indicates more difference than said first threshold, comparing a second difference parameter with a second threshold; or
if said comparison indicates less difference than said first threshold, indicating said fingerprint sample as verified.

26. The method according to claim 25, wherein said step of comparing said matrix difference with a threshold further comprises, if said comparison between said second parameter and said second threshold indicates less difference than said second threshold,
calculating a joint difference value from said first and second parameters;
comparing said joint difference value with a third threshold; and
if said comparison of said joint difference value with said third threshold indicates less difference than said third threshold, indicating said fingerprint sample as verified.

27. The method according to claim 9, wherein said searching for matching translation and rotation comprises comparing, for a plurality of translations and rotations, transforms of said fingerprint sample and said public part of fingerprint template.

28. The method according to claim 21, further comprising setting said element difference measure to null when either an element value of said aligned spectral matrix, or of said template matrix, or both, is uncertain.
